(19) United States
(12) Patent Application Publication
(10) Pub. No.: US 2013/0076738 A1
(43) Pub. Date: Mar. 28, 2013

(54) 3D DISPLAY METHOD AND SYSTEM WITH AUTOMATIC DISPLAY RANGE AND DISPLAY MODE DETERMINATION

(71) Applicants: PEIYUN JIAN, Shenzhen (CN); LEI SONG, Shenzhen (CN); NING LIU, Shenzhen (CN); ZHANG GE, Shenzhen (CN)

(72) Inventors: PEIYUN JIAN, Shenzhen (CN); LEI SONG, Shenzhen (CN); NING LIU, Shenzhen (CN); ZHANG GE, Shenzhen (CN)

(73) Assignee: SUPERD CO. LTD., Shenzhen (CN)

(21) Appl. No.: 13/628,235

(22) Filed: Sep. 27, 2012

(30) Foreign Application Priority Data
Sep. 27, 2011 (CN) 201110296666.2

(51) Int. Cl. G06T 15/00

(52) U.S. Cl. 345/419

(57) ABSTRACT

A method is provided for a three-dimensional (3D) display system containing a user position detection module and a 3D display panel. The method includes determining a viewing range of the 3D display panel based on characteristic information of the 3D display panel, and determining a detection range of the user position detection module. The method also includes determining a display range of the 3D display system as an overlapping area between the viewing range of the 3D display panel and the detection range of the user position detection system. Further, the method includes determining a display mode based on the display range of the 3D display system, and displaying contents to a user using the determined display mode.

### CROSS-REFERENCES TO RELATED APPLICATIONS

This application claims the priority of Chinese patent application number 201110296666.2, filed on Sep. 27, 2011, the entire contents of which are incorporated herein by reference.

### FIELD OF THE INVENTION

The present invention generally relates to 3D technologies and, more particularly, to the methods and systems for improved autostereoscopic display.

### BACKGROUND

Stereoscopic display systems can be divided into two categories according to the way of viewing: those viewable with naked eyes, and those viewable by wearing accessories (e.g., polarized glasses, shutter glasses). These two different viewing modes may cause users having different viewing experiences and also correspond to two different technical principles in technical implementations.

For the naked-eye three-dimensional (3D) display (i.e., autostereoscopic display), due to the characteristics of the optical imaging, there exists an effective 3D display range. When viewing within the effective 3D display range, a user can watch the 3D display effects in an ideal situation and without any unreal or inconsistent-with-reality viewing experience. However, when viewing outside the display range, the user may be unable to watch normal 3D display effects and likely only sees ghosting pictures.

Current 3D display technologies often do not have systematic approaches on how to determine the effective display range as well as what range to be used as the effective 3D display range, which may cause out-of-range display and undesired user experiences. The disclosed methods and systems are directed to solve one or more problems set forth above and other problems.

### BRIEF SUMMARY OF THE DISCLOSURE

One aspect of the present disclosure includes a method for a three-dimensional (3D) display system. The 3D display system includes a user position detection module and a 3D display panel. The method includes determining a viewing range of the 3D display panel based on characteristic information of the 3D display panel, and determining a detection range of the user position detection module. The method also includes determining a display range of the 3D display system as an overlapping area between the viewing range of the 3D display panel and the detection range of the user position detection system. Further, the method includes determining a display mode based on the display range of the 3D display system, and displaying contents to a user using the determined display mode.

Another aspect of the present disclosure includes a 3D display system. The 3D display system includes a user position detection module, a 3D display panel, a viewing distance determining unit, a detection range determining unit, a display range determining unit, and a display device. The 3D display panel has gratings on a display surface. The viewing distance determining unit is configured to determine a viewing range of the 3D display panel based on characteristic information of the 3D display panel; the detection range determining unit is configured to determine a detection range of the user position detection module; and the display range determining unit is configured to determine a display range of the 3D display system as an overlapping area between the viewing range of the 3D display panel and the detection range of the user position detection system. Further, the display device is configured to determine a display mode based on the display range of the 3D display system and to display contents to a user using the determined display mode.

Other aspects of the present disclosure can be understood by those skilled in the art in light of the description, the claims, and the drawings of the present disclosure.

### BRIEF DESCRIPTION OF THE DRAWINGS

FIG. 1 illustrates an exemplary range determination process consistent with the disclosed embodiments;

FIG. 2 illustrates an exemplary viewing range consistent with the disclosed embodiments;

FIG. 3 illustrates an exemplary detection range consistent with the disclosed embodiments;

FIG. 4 illustrates an exemplary display process consistent with the disclosed embodiments;

FIG. 5 illustrates an exemplary configuration for tracking-3D-display consistent with the disclosed embodiments;

FIG. 6 illustrates an exemplary display range determining device consistent with the disclosed embodiments;

FIG. 7 illustrates an exemplary display device consistent with the disclosed embodiments;

FIG. 8 illustrates an exemplary user position detection module consistent with the disclosed embodiments; and

FIG. 9 illustrates an exemplary autostereoscopic display system consistent with the disclosed embodiments.

### DETAILED DESCRIPTION

Reference will now be made in detail to exemplary embodiments of the invention, which are illustrated in the accompanying drawings. Wherever possible, the same reference numbers will be used throughout the drawings to refer to the same or like parts.

FIG. 9 illustrates an exemplary autostereoscopic display system 900. As shown in FIG. 9, the display system 900 includes a display panel 902, a controller 904, and a user position detection module 906. Other modules may also be included.

The display system 900 may include any appropriate device with certain 3D display capability, such as computers, TVs, tablets, smart phones and other mobile devices, etc. Display panel 902 may include any appropriate type of display screen based on plasma display panel (PDP) display, field emission display (FED), cathode ray tube (CRT) display, liquid crystal display (LCD), organic light emitting diode (OLED) display, or other types of displays. Further, the display panel 902 may also be touch-sensitive, i.e., a touch screen. Other display types may also be used.

The controller 904 may be configured to control operation of the display system 900 and/or the user position detection module 906, such as the control module in a computer, TV, tablet, smart phone, or other mobile device. The controller 904 may include any appropriate devices, such as a processor together with other devices such as random access memory (RAM), read-only memory (ROM), input/output interfaces, sensor driving circuitry, communication interfaces, and storage/database, etc. During operation, computer programs stored in the memory or other storage devices may be executed by the controller (i.e., the processor) to perform certain control functions and processes and/or to implement certain functional modules.

The user position detection module 906 may include any appropriate devices to detect a position or positions of a user or users, such as a video camera, a head sensor device, and/or a tracking device. The user position detection module 906 may interface with and/or controlled by the controller 904 to provide position information of the user.

In certain embodiments, the display system 900 (e.g., controller 904) may perform a process to determine an effective display range of the display system 900. FIG. 1 illustrates an exemplary range determination process 100.

As shown in FIG. 1, at the beginning of the process 100, controller 904 may determine a viewing range of the display panel 902 based on the characteristics of the display panel 902 and the characteristics of the gratings on the display panel 902 (e.g., slits or other parallax barriers) (101).

The display panel 902 may be superimposed a grating layer or a parallax barrier layer such that at least two parallax images can be provided to the user's left eye and right eye separately to effect a 3D display. More particularly, the gratings used in the display panel 902 may include slits or lenticular lenses, etc., and there may be a distance between the gratings to the display surface of the display panel 902.

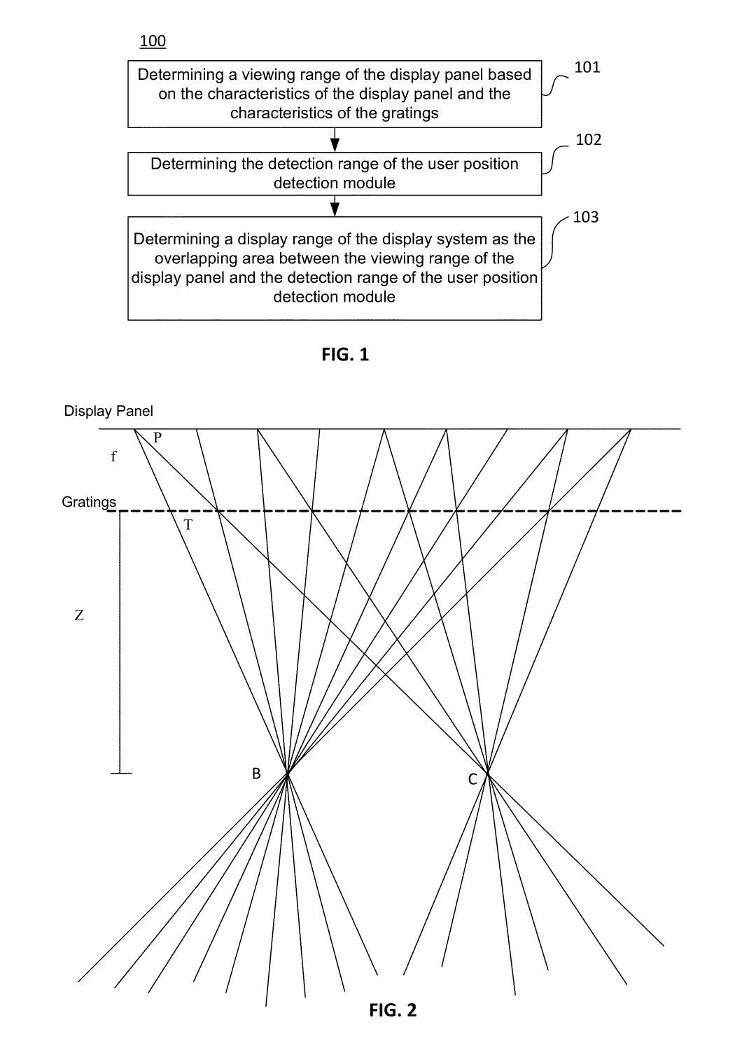

When imposed with the slits or lenticular lenses and due to the optical imaging, the display panel 902 has a viewing range, and the viewing range may be determined by various factors, such as the size of the display panel 904, the characteristics of the display panel 902 (e.g., viewing angle), and the characteristics of the gratings on the display panel 902 (e.g., slits, lenticular lenses). FIG. 2 illustrates an exemplary viewing range.

As shown in FIG. 2, P is the period of the pixels (i.e., pixel arrangement period) on the display panel 902, and T is the grating period, regardless of the slit grating or lenticular lenses. Thus, point B and point C are intersection points of the grating projection. When a user's eyes are in between the line segments BC, the user can view the normal 3D display effects.

With respect to a 3D display panel 902, the grating period T and the distance f, i.e., the distance from the grating layer to the surface of the display panel, are fixed. However, the period of the pixel arrangement on the display panel 902 may be adjusted in real time, so as to achieve a desired viewing distance, which is the distance between the display panel and the line segment BC.

More particularly, such determination can be represented by follows equations:

$$\{ \begin{matrix}\frac{P}{T} = \frac{f + Z}{Z} \\ \frac{BC}{T} = \frac{f + Z}{f} ,\end{matrix} \qquad Equation 1$$

from the Equation 1:

$$BC = \frac{T ( f + Z )}{f} . \qquad Equation 2$$

The value for BC may be set BC=2e, where e is the human eye average pupillary distance (e.g., 65 mm). Under this condition, the user can view a desired 3D display effect, and a corresponding distance from the user to the display panel is the desired viewing distance Z.

When the distance between the user and the display panel changes, the pixel arrangement period P may be changed such that the desired distance may be changed accordingly. Of course, the BC length may also change, and the BC length may have to be greater than the human eye pupil distance e for viewing the stereoscopic images being displayed. That is:

$$BC = \frac{T ( f + Z )}{f} \geq e , \qquad Equation 3$$

from the Equation 3:

$$Z \geq \frac{ef - Tf}{T} \qquad Equation 4$$

Thus, according to Equation 4

$$( Z \geq \frac{ef - TF}{T} ) ,$$

the minimum viewing distance can be determined as

$$\frac{ef - Tf}{T}$$

(i.e., the first viewing distance), and the maximum viewing distance is infinite (i.e., the second viewing distance).

In addition, the display panel 902 also has a horizontal viewing angle and a vertical viewing angle, which may be defined as fovh and fovv, respectively.

In certain embodiments, based on the horizontal viewing angle and the vertical viewing angle of the display panel 902, two planes forming the horizontal viewing angle and two planes forming the vertical viewing angle can be determined. Further, based on the above-described grating period and the distance between the grating and the display panel, the first viewing distance and the second viewing distance can also be determined.

Further, based on the first viewing distance, a near surface, i.e., the plane parallel to the display panel parallel at the first viewing distance, can be determined. Base on the second viewing distance, a far surface, i.e., the plane parallel to the display panel at the second viewing distance, can also be determined. The space formed by these two surfaces (i.e., the near surface and the far surface), the two planes forming the horizontal viewing angle, and the two planes forming the vertical viewing angle may be referred as the viewing range of the 3D display panel. Further, as described above, the first viewing distance and the second viewing distance are determined based on

$$Z \geq \frac{ef - Tf}{T} ,$$

wherein the first viewing distance may be determined as

$$\frac{ef - Tf}{T} ,$$

and the second viewing distance may be determined as infinite.

Thus, after the determination of the viewing range of the 3D display panel, the viewing range may be represented by pyramid platform formed by the horizontal viewing angle of the display panel, the vertical viewing angle of the display panel, the near surface parallel to the display panel at the first viewing distance, and the far surface parallel to the display panel at the second viewing distance. For the above described example with first viewing distance as

$$\frac{ef - Tf}{T} ,$$

and the second viewing distance as infinity, the viewing range of the display panel can be expressed as

$$( fovh , fovv , \frac{ef - Tf}{T} , + ∞ ) .$$

Returning to FIG. 1, after the viewing range of the display panel is determined (101), the detection range of the user position detection module 906 may also determined (102). The detection range of the user position detection module 906 may be limited by the detection range of the detection equipment in the user position detection module 906 and the detection precision of the detection equipment. FIG. 8 illustrates an exemplary user position detection module consistent with the disclosed embodiments.

As shown in FIG. 8, the user position detection module (i.e., the user position detection module 906) may include a detection equipment 802 and an analyzing equipment 804. Other devices may also be included.

The detection equipment 802 in the user position detection module 906 may be used to detect the user's eye position in real-time. For example, various detection technologies, such as ultrasonic, infrared, Bluetooth, and/or face tracking technologies, may be used to obtain information on the user's position. Regardless which detection technique is used, information about detection range and detection precision parameters of the detection equipment may be obtained.

As shown in FIG. 3, the detection range of the user position detection module 906 may be formed by two planes of the horizontal angle a of the user position detection module 906, two planes of the vertical angle b of the user position detection module 906, a near surface with a distance of OA from the user position detection module 906, and a far surface with a distance of OB from the user position detection module 906.

Similarly, a pyramid platform may be used to represent the detection range of the user position detection module 906. For example, the pyramid platform formed by the horizontal angle a of the user position detection module 906, the vertical angle b of the user position detection module 906, the near surface with distance OA from the user position detection module 906, and the far surface with distance OB from the user position detection module 906 may be used to define the detection range of the user position detection module 906, which can noted as (a, b, OA, OB). The detection range of the user position detection module 906 may be determined based on the characteristics of the detection technology used by using any appropriate algorithm.

Returning to FIG. 8, the analyzing equipment 804 is configured to determine position information of the user based on the attribute information of the user's position obtained by one or more channels of the detection equipment 802.

Returning to FIG. 1, after determining the detection range of the user position detection module 906, the display range of the autostereoscopic display system 900 may be determined (103). More specifically, the display range of the display system 900 may be determined as the overlapping area between the viewing range of the display panel and the detection range of the user position detection module 906.

In practice, the detection range of the user position detection module 906 (a, b, OA, OB) may be determined based on the detection center of the user position detection module 906. The detection center may be a center point of the image capturing in the lenses of a camera. The viewing range of the display panel

$$( fovh , fovv , \frac{ef - Tf}{T} , + ∞ )$$

may be determined based on the center of the display panel or a certain point on an extended center line perpendicular to the display panel. Because there may be an offset or a distance between the actually installed user position detection module 906 and the display panel, the display range determined based on the detection range and the viewing range may be a space of an irregular shape.

However, in general, the user position detection module 906 and the display panel may be placed at adjacent positions close to each other and, therefore, it can be approximated that the user position detection module 906 and the display panel use the same origin of the coordinate system. Thus, when determining the display range of the display system 900, i.e., when determining the overlapping space between the detection range and the viewing range, the detection range and the viewing range can be treated as having the same coordinate origin point. The display range of the display system 900 may then be a space of a regular shape.

Specifically, the display range of the autostereoscopic display system 900 may be formed by two planes of the horizontal angle of the display system 900, two planes of the vertical angle of the display system 900, the near surface with a first distance to the display system 900, and the far surface with a second distance to the display system 900, where the second distance is greater than the first distance. That is, to determine the display range of the display system 900, the two planes of the horizontal angle of the display system 900, the two planes of the vertical angle of the display system 900, the near surface with the first distance to the display system 900, and the far surface with the second distance to the display system 900 may be first determined. The space surrounded by these planes or surfaces is then determined as the display range of the display system 900.

Further, the horizontal angle of the display system 900 is the smaller one of the horizontal viewing angle fovh of the display panel 902 and the horizontal angle a of the user position detection module 906; and the vertical angle of the display system 900 is the smaller one of the vertical viewing angle fovh of the display system 900 and the vertical angle b of the user position detection module 906. The first distance is the larger one of the above-mentioned OA and the first viewing distance; and the second distance is the smaller one of the above-mentioned OB and the second viewing distance.

Similarly, a pyramid platform may be used to represent the display range of the display system 900. For example, the pyramid platform formed by the horizontal angle of the display system 900, the vertical angle of the display system 900, the near surface with the first distance to the display system 900, and the far surface with the second distance to the display system 900 may be used to define the display range of the display system 900, which can be noted as

$$( min ( fovh , a ) min ( fovv , b ) , max ( \frac{ef - Tf}{T} , OA ) , OB ) .$$

It should be noted that, by using the same origin of coordinates to determine the detection range of the user position detection module 906 and the viewing range of the display panel, complex algorithm, increased computational load, and inefficiency when determining the display range can be avoided. Further, because the display range determined is of a regular shape, further processing may be simpler and the processing efficiency may be significantly increased.

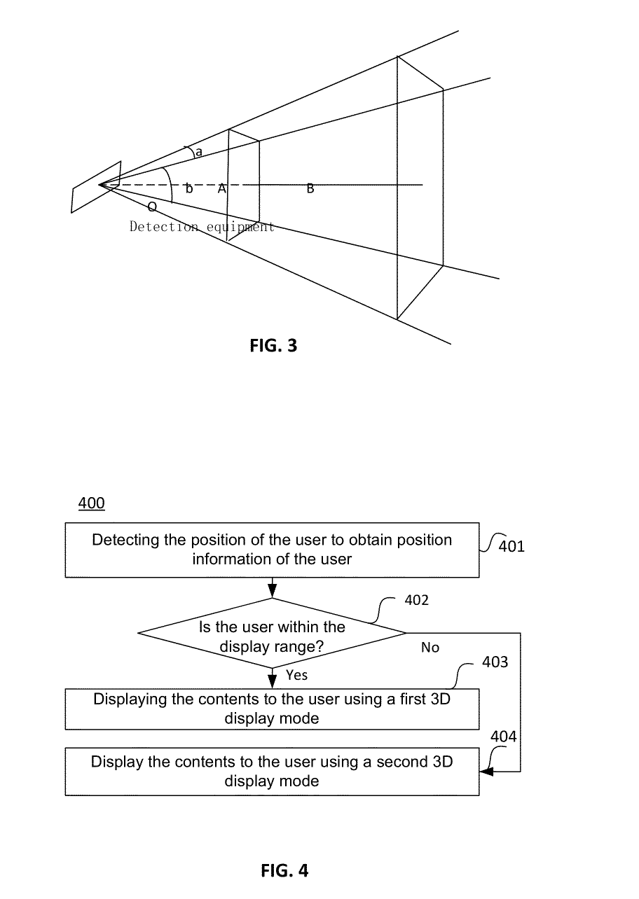

Further, after determining the display range of the display system 900, a display mode of the display system 900 may be determined based on the display range, and user contents may then be presented to the user using the determined display mode. FIG. 4 illustrates an exemplary display process 400 based on the display range of the display system 900.

As shown in FIG. 4, at the beginning of the process 400, the position of the user is detected to obtain position information of the user or users (401). For example, the position information of the user's eyes may be obtained in real-time by using the user position detection module 906 in the display system 900.

Further, based on the position information of the user, the system may determine whether the user is within the display range of the display system 900 (402). For example, the system may compare the coordinates of the user position with the space of the display range to determine whether the user is within the display range. If it is determined that the user is within the display range (402; Yes), the user contents are displayed to the user using a first 3D display mode (403). On the other hand, if it is determined that the user is not within the display range (402; No), the user contents are displayed to the user using a second 3D display mode (404).

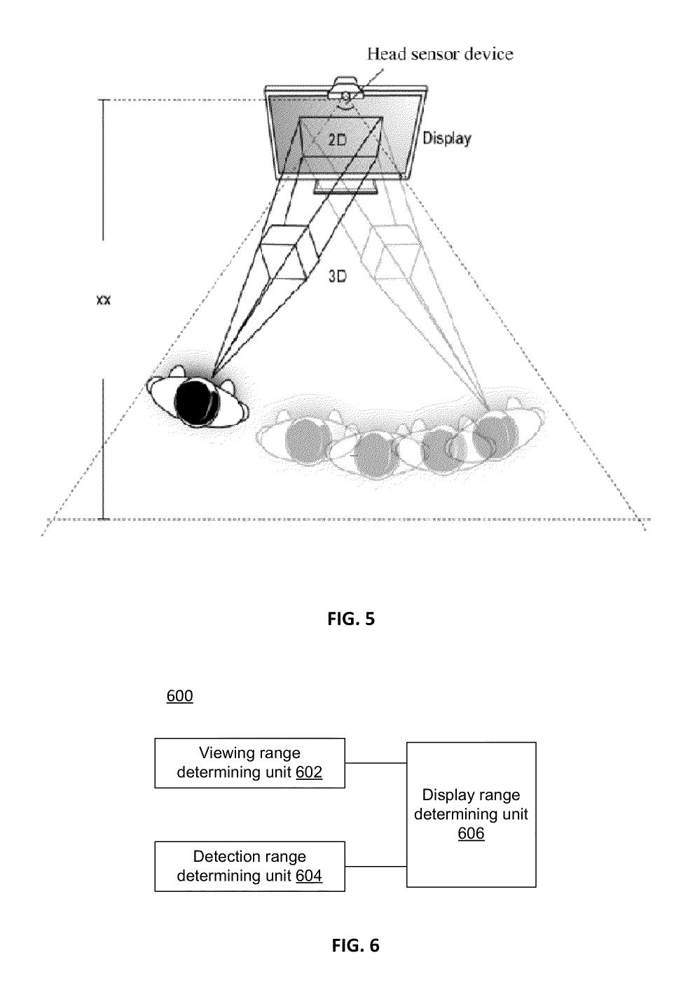

More particularly, when the user is within the display range, a tracking-3D-display mode may be used as the first 3D display mode to present contents to the user. FIG. 5 illustrates an exemplary configuration for the tracking-3D-display. As shown in FIG. 5, a head sensor device (i.e., the user position detection module 906) is used to keep track of the user (e.g., to determine that the user is within the display range).

That is, two or more sets of images (i.e., multiple view points) are used for autostereoscopic display of the user contents in the tracking-3D-display, and the user can view continuous and correct stereoscopic image sequences, without any discomfort caused by stereoscopic effects.

When operating in the tracking-3D-display mode, and if the distance d between the user and the display panel changes, the system may determine a corresponding pixel arrangement period P using certain algorithm, such as

$$P = \frac{( f + d ) T}{d} ,$$

where T is the grating period and f is the distance between the gratings and the display surface of the display panel. Further, the pixel arrangement period of display panel is adjusted according to the determined pixel arrangement period P. The adjusted pixel arrangement period of the display panel is then used to display the user contents.

On the other hand, when the user is outside the display range, a single-viewpoint-3D-display mode may be used as the second 3D display mode to present contents to the user.

When the user is outside the display range of the display system 900, the user may be outside the detection range of the user position detection module 906, the user may be outside the viewing range of the display panel 902, or the user's position information may be unable to be obtained (e.g., the user's face is obscured). Because the user position detection module 906 may use different detection technologies, different methods may be used when the user's position information indicates that the user is outside the display range of the display system 900.

For example, when the user position detection system 906 uses face tracking technology to obtain the user's position information, if the user is outside the detection range of the user position detection module 906, the user position detection module 906 may be unable to obtain face images of the user. The user position detection module 906 may use a preset default value as the user's position information. Based on the default value, it may be determined that the user is outside the display range of the display system 900.

If the user is located outside the viewing range of the display panel, but is within the detection range of the user position detection module 906, the user position detection module 906 may be able to obtain the user's position information. Because the position information is outside the viewing range, it can be determined that the user is outside the display range of the display system 900. Further, when the user's position information cannot be accurately obtained, such as when the user's face is blocked, the user position detection module 906 may be unable to recognize the user's face images. Similarly, the user position detection module 906 may also use the preset default value as the position information of the user to determine that the user is outside the display range of the display system 900.

When the user is not within the display range of the display system 900, the second 3D display mode, the single-viewpoint-3D-display mode, may be used to display the user contents. The single-viewpoint-3D-display mode may refer to the display mode where the 3D display is provided based on a fixed desired viewing distance no matter what position the user is in or whether there is a user viewing the display panel or a flat display is provided.

For example, in the single-viewpoint-3D-display mode, the desired viewing distance may be set as

$$Z = \frac{nef}{T} - f ,$$

and the pixel arrangement period may be set as

$$P = \frac{nefT}{nef - fT} ,$$

where n≧2. Such pixel arrangement period may then be used to provide users with the 3D display of the user contents.

Using n=2 as an illustrative example, and provided that BC=ne=2e.

$$\begin{matrix}BC = \frac{T ( f + Z )}{f} = 2 e & Equation 5 \\ Z = \frac{2 ef}{T} - f & Equation 6 \\ P = \frac{2 efT}{2 ef - fT} & Equation 7\end{matrix}$$

That is, when using

$$P = \frac{2 efT}{2 ef - fT}$$

to arrange the pixels dynamically, as shown in FIG. 2, the desired viewing distance (i.e., the distance between the display panel and the point B and point C is 2e. When the user is at the desired viewing distance

$$Z = \frac{2 ef}{T} - f ,$$

the user can view desired 3D display effects. In other words, in the single-viewpoint-3D-display, the user may need to search the desired viewing distance and/or position.

Alternatively, when the user is outside the display range of the display system 900, a flat output display may be used. That is, view images from a single viewpoint may be selected among the view images of multiple viewpoints, and the view images are then displayed in a 2D format. Further, the grating and dynamic pixel arrangement may be turned off. To the user, the autostereoscopic display system 900 is the same as an ordinary flat panel display system, which displays 2D images.

FIG. 6 illustrates an exemplary display range determining device 600 of the autostereoscopic display system 900. As shown in FIG. 6, the display range determining device 600 includes a viewing range determining unit 602, a detection range determining unit 604, and a display range determining unit 606. Other units may also be included.

The viewing range determining unit 602 is configured to determine a viewing range of the display panel 902 based on the characteristics of the display panel 902 and the characteristics of the gratings on the display panel 902 (e.g., slits or other parallax barriers).

More specifically, the viewing range determining unit 602 is configured to determine, based on the horizontal viewing angle and the vertical viewing angle of the display panel 902, two planes forming the horizontal viewing angle and two planes forming the vertical viewing angle. The viewing range determining unit 602 is also configured to determine, based on the grating period of the gratings on the display panel and the distance between the gratings and the display panel, the first viewing distance and the second viewing distance, and to determine two surfaces parallel to the display panel at the first viewing distance and the second viewing distance, respectively, from the display panel. The viewing range determining unit 602 is further configured to determine the space formed by the two surfaces, the two planes forming the horizontal viewing angle, and two planes forming the vertical viewing angle as the viewing range of the display panel.

For example, the viewing range determining unit 602 may determine, according to

$$Z \geq \frac{ef - Tf}{T} ,$$

the first viewing distance as

$$\frac{ef - Tf}{T}$$

and the second viewing distance as infinite, where e is the human eye average pupillary distance, f is the distance between the gratings and the display panel, T is the grating period, and Z is the distance between the user and the display panel.

The characteristic information of the display panel and the grating attribute information of the display panel can be configured in the display panel such that the viewing range determining unit 602 may retrieve such information from the display panel when determining the viewing range of the display panel. The characteristic information of the display panel and the grating attribute information of the display panel can also be configured directly in the viewing range determining unit 602. When the viewing range determining unit 602 determines the viewing range of the display panel, the viewing range determining unit 602 may directly use the internally stored characteristic information of the display panel and the grating attribute information of the display panel to perform computation.

Further, the detection range determining unit 604 is configured to determine the detection range of the user position detection module 906. Similarly, the parameters required for determining the detection range of the user position detection module 906 may also be configured in the user position detection module 906 or in the detection range determining unit 604.

The display range determining unit 606 is configured to determine the display range of the display system 900 as the overlapping area between the viewing range of the display panel and the detection range of the user position detection module 906.

More specifically, when the detection range of the user position detection module 906 is formed by two planes of the horizontal angle a of the user position detection module 906, two planes of the vertical angle b of the user position detection module 906, a near surface with a distance of OA from the user position detection module 906, and a far surface with a distance of OB from the user position detection module 906, the display range determining unit 606 is configured to determine two planes of the horizontal angle of the display system 900, two planes of the vertical angle of the display system 900, the near surface with a first distance to the display system 900, and the far surface with a second distance to the display system 900, where the second distance is greater than the first distance.

Further, the display range determining unit 606 is configured to determine the display range of the display system 900 as the space surrounded by these planes or surfaces. For example, the horizontal angle of the display system 900 is the smaller one of the horizontal viewing angle fovh of the display panel 902 and the horizontal angle a of the user position detection module 906; and the vertical angle of the display system 900 is the smaller one of the vertical viewing angle fovh of the display system 900 and the vertical angle b of the user position detection module 906. The first distance is the larger one of the above-mentioned OA and the first viewing distance; and the second distance is the smaller one of the above-mentioned OB and the second viewing distance.

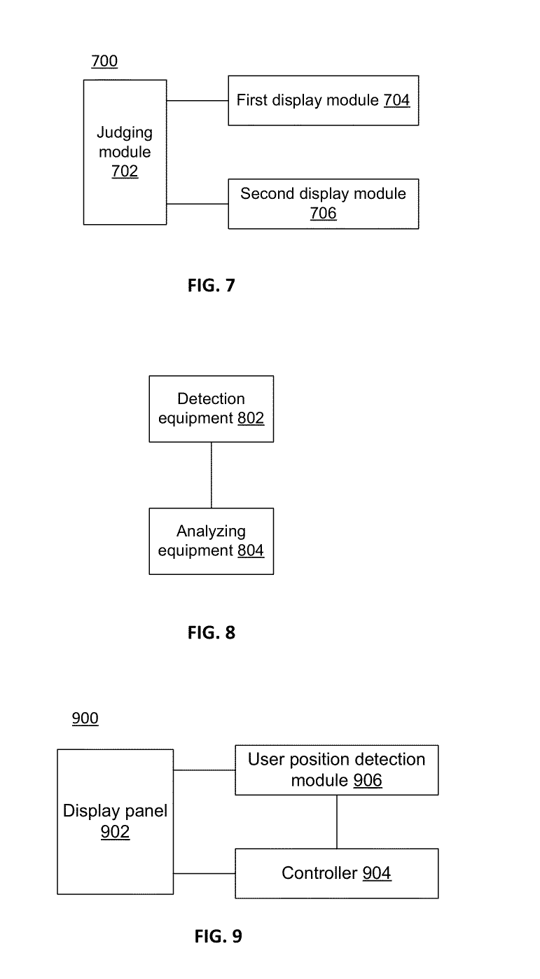

FIG. 7 illustrates an exemplary display device 700 of the display system 900. As shown in FIG. 7, the display device 700 includes a judging module 702, a first display module 704, and a second display module 706. Other modules may also be included.

The judging module 702 may be configured to judge whether the user is within the display range of the display system 900 based on obtained user position information.

The first display module 704 is configured to display the user contents to the user using a first 3D display mode, when the judging module 702 determines that the user is within the display range of the display system 900. For example, the first display module 704 may use the tracking-3D-display mode as the first 3D display mode to present contents to the user.

When the distance d between the user and the display panel changes, the first display module 704 determines a corresponding pixel arrangement period P using certain algorithm, such as

$$P = \frac{( f + d ) T}{d} ,$$

where T is the grating period and f is the distance between the grating and the display panel. Further, the first display module 704 adjusts the pixel arrangement period of display panel according to the determined pixel arrangement period P. The first display module 704 then displays the user contents using the adjusted pixel arrangement period of the display panel.

The second display module 706 is configured to display the user contents to the user using a second 3D display mode, when the judging module 702 determines that the user is not within the display range of the display system 900. For example, the second display module 706 may use the single-viewpoint-3D-display mode as the second 3D display mode to display the contents to the user.

In the single-viewpoint-3D-display mode, the second display module 706 may display the contents based on a fixed desired viewing distance no matter what position the user is in or whether there is a user viewing the display panel. For example, the second display module 706 may set the desired viewing distance as

$$Z = \frac{nef}{T} - f$$

and the pixel arrangement period as

$$P = \frac{nefT}{nef - fT} ,$$

where n≧2. The second display module 706 may then use the calculated pixel arrangement period to provide users with the 3D display of the contents.

Alternatively, the second display module 706 may also selects view images from a single viewpoint among the view images of multiple viewpoints, and then displays the selected view images in a 2D format.

By using the disclosed systems and methods, improved 3D display applications can be implemented. For example, different display modes may be automatically switched based on whether the user is within the display range of the autostereoscopic display system. Even when the user is outside the display range of the autostereoscopic display system, the user can still view normally displayed contents, improving the user viewing experience. Other advantageous applications, modifications, substitutions, improvements are also obvious to those skilled in the art.

What is claimed is:

1. A method for a three-dimensional (3D) display system including a user position detection module and a 3D display panel, comprising:
determining a viewing range of the 3D display panel based on characteristic information of the 3D display panel;
determining a detection range of the user position detection module;
determining a display range of the 3D display system as an overlapping area between the viewing range of the 3D display panel and the detection range of the user position detection system;
determining a display mode based on the display range of the 3D display system; and
displaying contents to a user using the determined display mode.

2. The method according to claim 1, wherein determining the viewing range of the 3D display panel further includes:
determining two planes forming a horizontal viewing angle of the 3D display panel;
determining two planes forming a vertical viewing angle of the 3D display panel;
determining a first viewing distance and a second viewing distance based on a grating period of the 3D display panel and a distance between gratings and a display surface of the 3D display panel;
determining a near surface parallel to the 3D display panel at the first viewing distance and a far surface parallel to the display panel at the second viewing distance; and
determining the viewing range as a space formed by the two planes forming the horizontal viewing angle, the two planes forming the vertical viewing angle, the near surface, and the far surface.

3. The method according to claim 2, wherein determining the first viewing distance and the second viewing distance further include:
provided that e is a human eye average pupillary distance, f is a distance between the gratings and the display surface of the 3D display panel, T is the grating period, and Z is a distance between the user and the 3D display panel, determining the first viewing distance as
$$\frac{ef - Tf}{T} ,$$
based on
$$Z \geq \frac{ef - Tf}{T} ,$$
and the second viewing distance as infinite.

4. The method according to claim 2, wherein:
when the detection range of the user position detection module is formed by two planes of a horizontal angle of the user position detection module, two planes of a vertical angle of the user position detection module, a first surface with a distance of OA from the user position detection module, and a second surface with a distance of OB from the user position detection module, determining two planes of a horizontal angle of the 3D display system, two planes of a vertical angle of the 3D display system, a near surface with a first distance to the 3D display system, and a far surface with a second distance to the 3D display system,
wherein the horizontal angle of the 3D display system is smaller one of the horizontal viewing angle of the 3D display panel and the horizontal angle of the user position detection module; the vertical angle of the 3D display system is smaller one of the vertical viewing angle of the 3D display system and the vertical angle of the user position detection module; the first distance is larger one of the distance OA and the first viewing distance; and the second distance is smaller one of the distance OB and the second viewing distance.

5. The method according to claim 1, wherein determining the display mode further includes:
obtaining position information of the user;
determining whether the user is within the display range of the 3D display system;
when the user is within the display range of the 3D display system, displaying the contents using a first 3D display mode as the display mode; and
when the user is not within the display range of the 3D display system, displaying the contents using a second 3D display mode as the display mode.

6. The method according to claim 5, further including:
in the first display mode, when distance d between the user and the display panel changes, determining a corresponding pixel arrangement period
$$P = \frac{( f + d ) T}{d} .$$

7. The method according to claim 5, further including:
in the second display mode, provided that T is a grating period, n is an integer and n≧2, and f is a distance between the gratings and the display surface, obtaining a fixed desired viewing distance as
$$Z = \frac{nef}{T} - f ,$$
and determining a corresponding pixel arrangement period as
$$P = \frac{nefT}{nef - fT} .$$

8. A three-dimensional (3D) display system, comprising:
a user position detection module;
a 3D display panel having gratings on a display surface;
a viewing distance determining unit configured to determine a viewing range of the 3D display panel based on characteristic information of the 3D display panel;
a detection range determining unit configured to determine a detection range of the user position detection module;
a display range determining unit configured to determine a display range of the 3D display system as an overlapping area between the viewing range of the 3D display panel and the detection range of the user position detection system; and
a display device configured to determine a display mode based on the display range of the 3D display system and to display contents to a user using the determined display mode.

9. The 3D display system according to claim 8, wherein the viewing range determining unit is further configured to:
determine two planes forming a horizontal viewing angle of the 3D display panel;
determine two planes forming a vertical viewing angle of the 3D display panel;
determine a first viewing distance and a second viewing distance based on a grating period of the 3D display panel and a distance between gratings and a display surface of the 3D display panel;
determine a near surface parallel to the 3D display panel at the first viewing distance and a far surface parallel to the display panel at the second viewing distance; and
determine the viewing range as a space formed by the two planes forming the horizontal viewing angle, the two planes forming the vertical viewing angle, the near surface, and the far surface.

10. The 3D display system according to claim 9, wherein, to determine the first viewing distance and the second viewing distance, the viewing range determining unit is further configured to:
provided that e is a human eye average pupillary distance, f is a distance between the gratings and the display surface of the 3D display panel, T is the grating period, and Z is a distance between the user and the 3D display panel, determine the first viewing distance as
$$\frac{ef - Tf}{T} ,$$
based on
$$Z \geq \frac{ef - Tf}{T} ,$$
and the second viewing distance as infinite.

11. The 3D display system according to claim 9, wherein the display range determining unit is further configured to:
when the detection range of the user position detection module is formed by two planes of a horizontal angle of the user position detection module, two planes of a vertical angle of the user position detection module, a first surface with a distance of OA from the user position detection module, and a second surface with a distance of OB from the user position detection module, determine two planes of a horizontal angle of the 3D display system, two planes of a vertical angle of the 3D display system, a near surface with a first distance to the 3D display system, and a far surface with a second distance to the 3D display system,
wherein the horizontal angle of the 3D display system is smaller one of the horizontal viewing angle of the 3D display panel and the horizontal angle of the user position detection module; the vertical angle of the 3D display system is smaller one of the vertical viewing angle of the 3D display system and the vertical angle of the user position detection module; the first distance is larger one of the distance OA and the first viewing distance; and the second distance is smaller one of the distance OB and the second viewing distance.

12. The 3D display system according to claim 8, wherein the display device further includes:
a judging module configured to obtain position information of the user and to determine whether the user is within the display range of the 3D display system;
a first display module configured to, when the user is within the display range of the 3D display system, display the contents using a first 3D display mode as the display mode; and
a second display module configured to, when the user is not within the display range of the 3D display system, display the contents using a second 3D display mode as the display mode.

13. The 3D display system according to claim 12, wherein the first display module is further configured to:
when in the first display mode and distance d between the user and the display panel changes, determine a corresponding pixel arrangement period
$$P = \frac{( f + d ) T}{d} .$$

14. The 3D display system according to claim 12, wherein the second display module is further configured to:
when in the second display mode, provided that T is a grating period, n is an integer and n≧2, and f is a distance between the gratings and the display surface, obtain a fixed desired viewing distance as
$$Z = \frac{nef}{T} - f ,$$
and;
determine a corresponding pixel arrangement period as
$$P = \frac{nefT}{nef - fT} .$$
